(19) United States
(12) Patent Application Publication
(10) Pub. No.: US 2025/0223991 A1
(43) Pub. Date: Jul. 10, 2025

(54) MULTI-PIECE FASTENERS, FASTENING COLLAR INSTALLATION APPARATUS, AND METHODS OF FASTENING

(71) Applicant: Howmet Aerospace Inc., Pittsburgh, PA (US)

(72) Inventors: Robert B. Wilcox, McGregor, TX (US); Thomas R. Kingsbury, Hewitt, TX (US)

(21) Appl. No.: 19/091,404

(22) Filed: Mar. 26, 2025

Related U.S. Application Data
(63) Continuation of application No. 17/754,026, filed on Mar. 22, 2022.

(51) Int. Cl. F16B 19/05; F16B 5/04

(52) U.S. Cl. CPC F16B 19/05; F16B 5/04

(57) ABSTRACT

Multi-piece fasteners, fastening collar installation apparatus, and methods of fastening are provided. The multi-piece fastener comprises a fastening collar and a pin. The fastening collar comprises a first collar end, a second collar end, and a collar cavity. The collar cavity extends from the first collar end to the second collar end. The pin is configured to be at least partially received by the collar cavity. The pin comprises a first pin end comprising a head portion, a second pin end comprising a pull region, and a shank. The pull region is generally cylindrical and smooth and is configured to form at least one of an annular shoulder, a groove, a thread, and other feature responsive to forcible contact from a fastening collar installation apparatus. The shank extends intermediate the first pin end and the second pin end. The fastening collar is configured to be deformed onto the shank.

### FIELD OF USE

The present disclosure relates to multi-piece fasteners, fastening collar installation apparatus, and methods of fastening.

### BACKGROUND

Vehicle frames, storage racks, solar panel sub-structures, aircraft parts, and other structures can include numerous mechanical fasteners. For example, a structural fastener can be installed in a bore of a structural component to secure parts together. Properly installing a structural fastener into a bore presents challenges.

### SUMMARY

According to one aspect of the present disclosure, a multi-piece fastener is provided. The multi-piece fastener comprises a fastening collar and a pin. The fastening collar comprises a first collar end, a second collar end, and a collar cavity. The collar cavity extends from the first collar end to the second collar end. The pin is configured to be at least partially received by the collar cavity. The pin comprises a first pin end comprising a head portion, a second pin end comprising a pull region, and a shank. The pull region is generally cylindrical and smooth and is configured to form at least one of an annular shoulder, a groove, a thread, and other feature thereon responsive to forcible contact from a fastening collar installation apparatus. The shank extends intermediate the first pin end and the second pin end. The fastening collar is configured to be deformed onto at least a region of the shank.

According to another aspect of the present disclosure, a fastening collar installation apparatus is provided. The fastening collar installation apparatus comprises a housing, an anvil, and a collet. The housing comprises a first housing end, a second housing end, and a housing cavity extending from the first housing end to the second housing end. The anvil and the collet are positioned within the housing cavity. The collet comprises a first collet end adjacent to the anvil. The first collet end comprises jaws configured to forcibly contact at least a portion of a pull region of a multi-piece fastener and to form at least one of an annular shoulder, a groove, a thread, and other feature on the pull region.

According to yet another aspect of the present disclosure, a method for fastening is provided. The method comprises inserting a second pin end of a pin of a multi-piece fastener into a bore in a structure. The multi-piece fastener comprises a fastening collar and the pin. The fastening collar comprises a first collar end, a second collar end, and a collar cavity. The collar cavity extends from the first collar end to the second collar end. The pin is configured to be at least partially received by the collar cavity. The pin comprises a first pin end comprising a head portion, a second pin end comprising a pull region, and a shank. The pull region is generally cylindrical and smooth and is configured to form at least one of an annular shoulder, a groove, a thread, and other feature responsive to forcible contact from a fastening collar installation apparatus. The shank extends intermediate the first pin end and the second pin end. The fastening collar is configured to be deformed onto the shank. Additionally, the method comprises passing at least a portion of the second pin end through the collar cavity. The pull region of the pin is forcibly contacted with jaws of a collet of a fastening collar installation apparatus, and at least one of an annular shoulder, a groove, a thread, and other feature is formed on the pull region by the jaws. The fastening collar is forcibly contacted with an anvil of the fastening collar installation apparatus, and the pull region is moved distal from the fastening collar utilizing the collet of the fastening collar installation apparatus, thereby deforming the fastening collar onto the shank of the pin and securing at least a portion of the multi-piece fastener in the structure.

It will be understood that the invention disclosed and described in this specification is not limited to the aspects summarized in this Summary. The reader will appreciate the foregoing details, as well as others, upon considering the following detailed description of various non-limiting and non-exhaustive aspects according to this specification.

### BRIEF DESCRIPTION OF THE DRAWINGS

The features and advantages of the examples presented herein, and the manner of attaining them, will become more apparent, and the examples will be better understood, by reference to the following description taken in conjunction with the accompanying drawings, wherein:

FIG. 1A is a perspective view of a non-limiting embodiment of a multi-piece fastener according to the present disclosure;

FIG. 1B is a cross-sectional side view of a non-limiting embodiment of the multi-piece fastener of FIG. 1A taken along line 1B-1B of FIG. 1A;

FIG. 2A is a perspective view of a non-limiting embodiment of a fastening collar installation apparatus according to the present disclosure;

FIG. 2B is a cross-sectional side view of a non-limiting embodiment of the fastening collar installation apparatus of FIG. 2A taken along line 2B-2B of FIG. 2A;

FIG. 3 is a detail view of a non-limiting embodiment of jaws of a collet of an installation apparatus according to the present disclosure, wherein the jaws comprise grooves;

FIG. 4 is a detail view of a non-limiting embodiment of jaws of a collet of an installation apparatus according to the present disclosure, wherein the jaws comprise helical threads;

FIG. 5A is a cross-sectional side view of a non-limiting embodiment of a multi-piece fastener system and a structure according to the present disclosure;

FIG. 5B is a cross-sectional side view of the multi-piece fastener of FIG. 5A engaged with a non-limiting embodiment of a fastening collar installation tool according to the present disclosure;

FIG. 5C is a cross-sectional side view of a non-limiting embodiment of the multi-piece fastener of FIG. 5B with the fastening collar at least partially deformed onto a shank of a pin of the multi-piece fastener;

FIG. 5D is a cross-sectional side view of a non-limiting embodiment of the multi-piece fastener of FIG. 5C installed into the structure; and

FIG. 6 is a flow chart of a non-limiting embodiment of a method for fastening according to the present disclosure.

Corresponding reference characters indicate corresponding parts throughout the several views. The exemplifications set out herein illustrate certain embodiments, in one form, and such exemplifications are not to be construed as limiting the scope of the appended claims in any manner.

### DETAILED DESCRIPTION OF NON-LIMITING EMBODIMENTS

Various embodiments are described and illustrated herein to provide an overall understanding of the structure, function, and use of the multi-piece fasteners, and methods of fastening. The various embodiments described and illustrated herein are non-limiting and non-exhaustive. Thus, the invention is not limited by the description of the various non-limiting and non-exhaustive embodiments disclosed herein. Rather, the invention is defined solely by the claims. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant reserves the right to amend the claims to affirmatively disclaim features or characteristics that may be present in the prior art. The various embodiments disclosed and described in this specification can comprise, consist of, or consist essentially of the features and characteristics as variously described herein.

Any references herein to “various embodiments,” “some embodiments,” “one embodiment,” “an embodiment,” or like phrases mean that a particular feature, structure, or characteristic described in connection with the embodiment is included in at least one embodiment. Thus, appearances of the phrases “in various embodiments,” “in some embodiments,” “in one embodiment,” “in an embodiment,” or like phrases in the specification do not necessarily refer to the same embodiment. Furthermore, the particular described features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation. Such modifications and variations are intended to be included within the scope of the present embodiments.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

The grammatical articles “a,” “an,” and “the,” as used herein, are intended to include “at least one” or “one or more,” unless otherwise indicated, even if “at least one” or “one or more” is expressly used in certain instances. Thus, the foregoing grammatical articles are used herein to refer to one or more than one (i.e., to “at least one”) of the particular identified elements. Further, the use of a singular noun includes the plural, and the use of a plural noun includes the singular, unless the context of the usage requires otherwise.

As used herein, “intermediate” means that the referenced element is disposed between two elements but is not necessarily in contact with those elements. Accordingly, unless stated otherwise herein, an element that is “intermediate” a first element and a second element may or may not be adjacent to or in contact with the first and/or second elements, and other elements may be disposed between the intermediate element and the first and/or second elements.

Installing a lockbolt can comprise axially moving the pin of the fastener distal from a fastening collar of the fastener system and swaging the fastening collar. Moving the pin can require a collet of an installation tool to engage or otherwise grip the pin. Typically, the pin can comprise a pull section with a gripping feature that can be engaged by the collet, such as, for example, an annular shoulder, a groove, a thread, or other feature. The gripping feature can be difficult to form during a rolling procedure. Additionally, forming the gripping feature on the pull section of the pin adds time and cost to the manufacturing process. Accordingly, multi-piece fasteners, fastening collar installation apparatus, and methods of fastening are provided that may not require a gripping feature to be provided on a pull region of a pin of the multi-piece fastener.

Additionally, the multi-piece fasteners, fastening collar installation apparatus, and methods of fastening according to the present disclosure can provide a visual indication that the fastener has been installed, which can save inspection time.

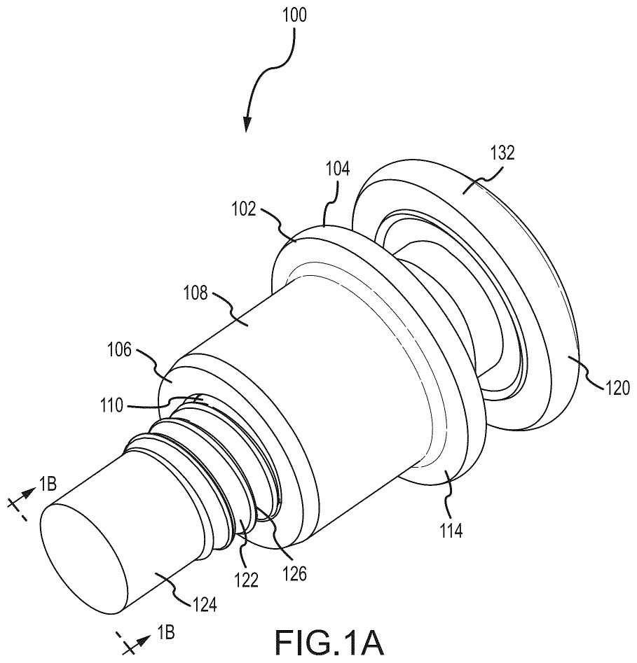

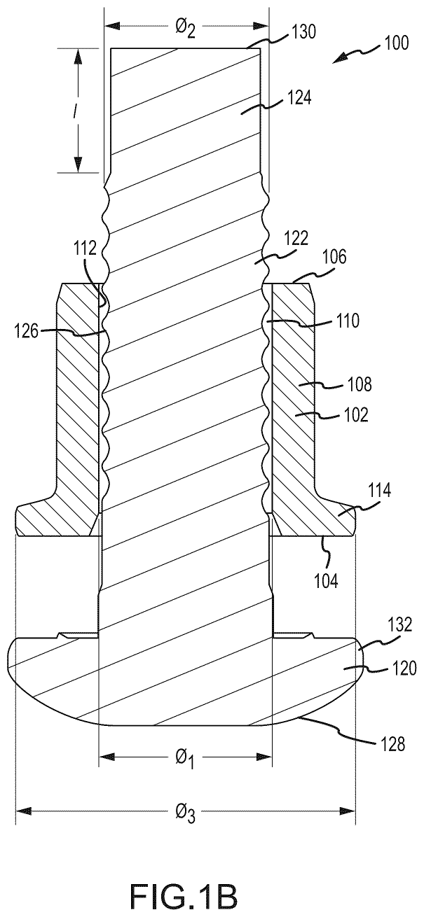

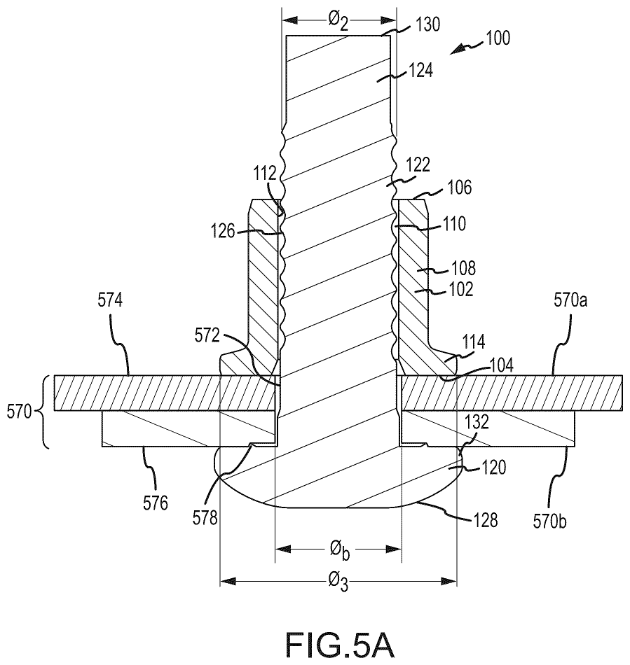

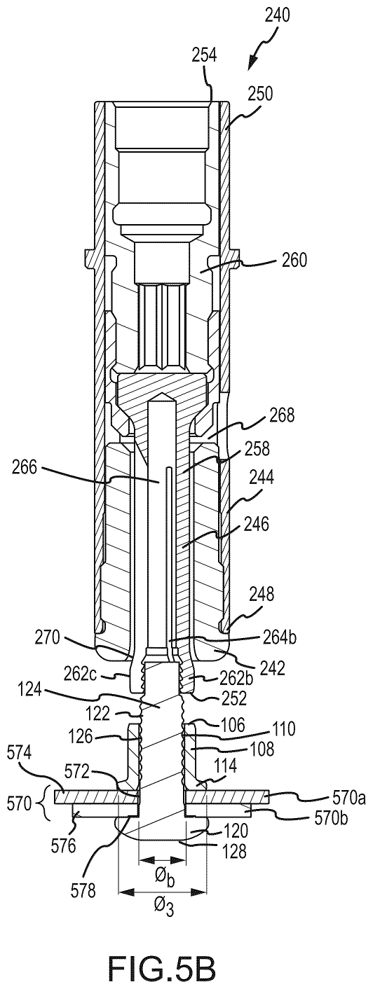

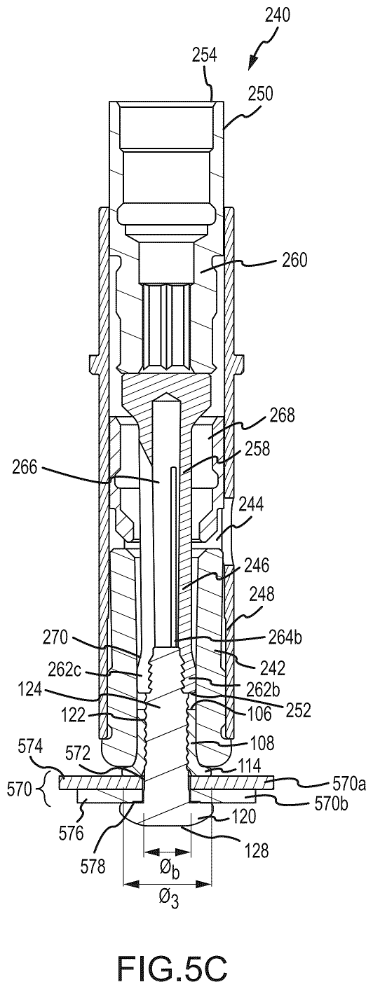

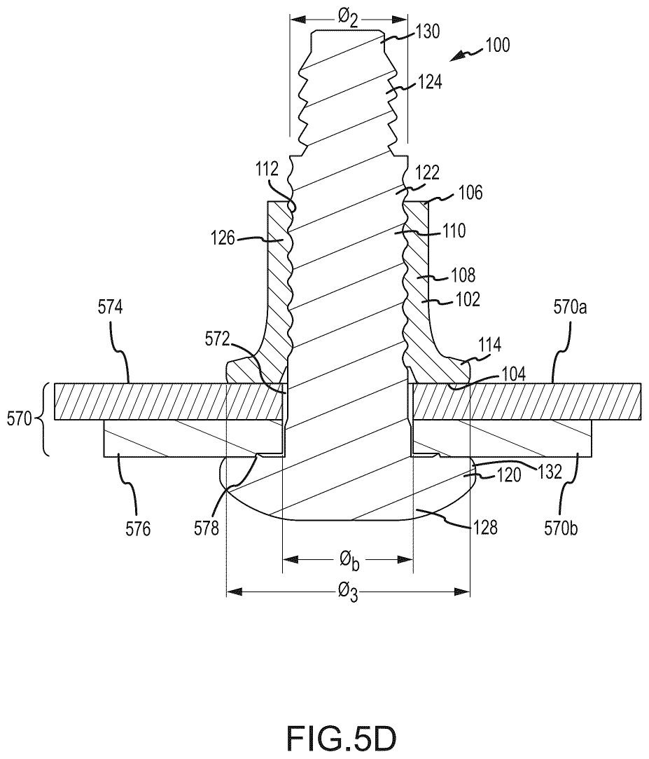

FIGS. 1A-1B illustrate a non-limiting embodiment of a multi-piece fastener 100 according to the present disclosure. The multi-piece fastener 100 can be adapted to be installed in a bore in a structure (e.g., as illustrated in FIGS. 5A-5D and discussed below). The multi-piece fastener 100 can comprise at least two components, such as, for example, a fastening collar 102 and a pin 120 as illustrated in FIGS. 1A-1B, or in some non-limiting embodiments, at least three components (not shown). In various non-limiting embodiments, the multi-piece fastener 100 can comprise a two-piece assembly, including the fastening collar 102 and the pin 120. In some non-limiting embodiments, the multi-piece fastener 100 can comprise a lockbolt. For example, the lockbolt can be a structural lockbolt fastener, such as, for example, a structural rivet, a structural bolt, or a structural stud.

The fastening collar 102 can comprise a first collar end 104, a second collar end 106, an elongate portion 108 disposed intermediate the first collar end 104 and the second collar end 106, and a collar cavity 110 extending through the elongate portion 108 from the first collar end 104 to the second collar end 106. The elongate portion 108 can define a longitudinal axis of the fastening collar 102 and/or the multi-piece fastener 100. An inner surface 112 of the elongate portion 108 defining the collar cavity 110 can comprise at least one of a substantially cylindrical region, a threaded region, an annular shoulder, a groove, and other feature depending on the desired application. The fastening collar 102 can be sized and configured to engage with a fastening collar installation tool. Responsive to the engagement, the fastening collar 102 can be deformed onto a shank 122 of a pin 120 of the multi-piece fastener 100 to achieve a desired clamping force between the fastening collar 102 and the pin 120.

The pin 120 can comprise a first pin end 128, a second pin end 130, and the shank 122. The shank 122 can comprise a shape and size suitable to be received by the collar cavity 110 of the fastening collar 102, such as, for example, a generally cylindrical shape. The shank 122 can extend intermediate the first pin end 128 and the second pin end 130 and can be dimensioned so that it can be disposed at least partially through the collar cavity 110. When the shank 122 is inserted in the collar cavity 110, the second pin end 130 can be disposed adjacent to the second collar end 106, and the first pin end 128 can be disposed adjacent to the first collar end 104. The first pin end 128 can comprise a head portion 132 configured to inhibit the pin 120 from traversing completely through a bore in a structure. For example, a diameter of a bore in a structure can comprise a diameter less than a diameter of the head portion 132 so that the head portion 132 cannot pass through the bore.

The collar cavity 110 can be configured to receive the pin 120. For example, the collar cavity 110 can comprise a first diameter, Ø₁, greater than a second diameter, Ø₂, of the shank 122. The fastening collar 102 can comprise a flange 114 comprising a third diameter, Ø₃, sized and configured in order to inhibit the flange 114 of the fastening collar 102 from traversing through a bore in a structure. In various non-limiting embodiments, the fastening collar 102 can be generally cylindrical.

In various non-limiting embodiment, the second diameter, Ø₂, of the shank 122 can be at least 0.06 inches, such as, for example, at least 0.1 inch, at least 0.5 inches, or at least 1 inch. In various non-limiting embodiments, the second diameter, Ø₂, of the shank 122 can be no greater than 4 inches, such as, for example, no greater than 1 inch, no greater than 0.5 inches, or no greater than 0.1 inch. In various non-limiting embodiments, the second diameter, Ø₂, of the shank 122 can be in a range of 0.06 inches to 4 inches, such as, for example, 0.06 inches to 1 inches, or 0.06 inches to 0.5 inches.

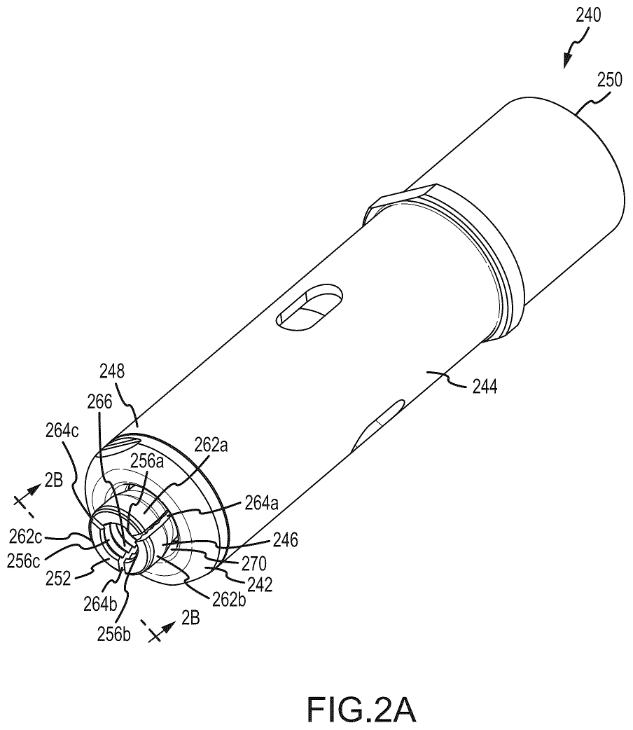

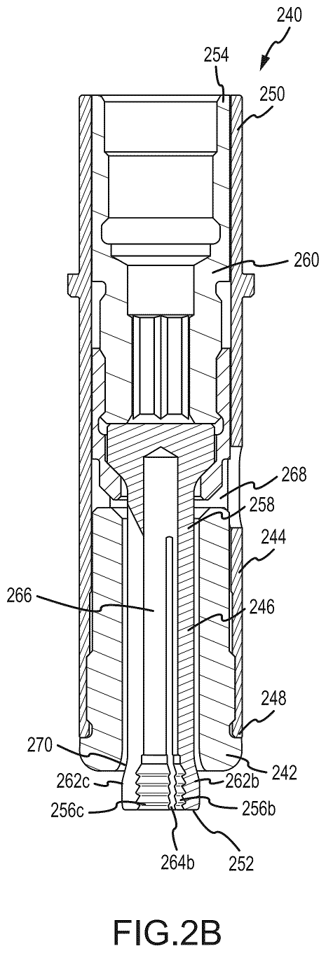

The second pin end 130 can comprise a pull region 124 configured to be engaged by a fastening collar installation apparatus (e.g., fastening collar installation apparatus 240, as illustrated in FIGS. 2A-2B and discussed below). The pull region 124 can comprise an axial length, l, sized to be engaged by an installation tool. For example, in various non-limiting embodiments, the axial length, l, can be at least 0.5 times the second diameter, Ø₂, of the shank 122, such as, for example, at least 1 times the second diameter, Ø₂, of the shank 122, at least 2 times the second diameter, Ø₂, of the shank 122, or at least 3 times the second diameter, Ø₂, of the shank 122. In various non-limiting embodiments, the axial length, l, can be no greater than 4 times the second diameter, Ø₂, of the shank 122, such as, for example, no greater than 3 times the second diameter, Ø₂, of the shank 122, no greater than 2 the second diameter, Ø₂, of the shank 122, or no greater than 1 times the second diameter, Ø₂, of the shank 122. In certain non-limiting embodiments, the axial length, l, can be in a range of 0.5 to 4 times the second diameter, Ø₂, of the shank 122, such as for example, 0.5 times to 2 times the second diameter, Ø₂, of the shank 122.

In certain non-limiting embodiments, the pull region 124 may not comprise a taper. In various other non-limiting embodiments, the pull region 124 may comprise a taper or a reverse taper. For example, as one moves along the pull region 124 away from the shank 122 along a longitudinal axis of the pin 120, the diameter of the pull region 124 can decrease. In certain other non-limiting embodiments, the pull region 124 can comprise a reverse taper in which, as one moves along the pull region 124 away from the shank 122 along the longitudinal axis of the pin 120, the diameter of the pull region 124 can increase.

In certain non-limiting embodiments, the pull region 124 can be generally cylindrical and smooth. For example, the pull region 124 can be free of an annular shoulder, grooves, threads, or other features prior to forcible contact with a fastening collar installation apparatus. In various non-limiting embodiments, the annular shoulder, groove, thread, or other feature can form on the pull region 124 responsive to forcible contact with a fastening collar installation apparatus. The formation of the annular shoulder, groove, thread, and/or other feature on the pull region 124 can be responsive to installation of the multi-piece fastener 100 into a structure and, thus, provides a visual indication that the multi-piece fastener 100 has been installed into the structure.

The shank 122 can define the longitudinal axis of the pin 120 and/or the multi-piece fastener 100. The shank 122 can be configured to engage the fastening collar 102 on installation in order to secure the shank 122 to the fastening collar 102. In various non-limiting embodiments, upon engagement of the pin 120 and the collar 102 when the components are installed, the longitudinal axis of the pin 120 and the longitudinal axis of the fastening collar 102 can be substantially aligned and form the longitudinal axis of the multi-piece fastener 100.

In various non-limiting embodiments, the shank 122 of the pin 120 can comprise at least one of a generally smooth region, a threaded region, an annular shoulder, a groove, and other feature that is adapted to engage the surface 112 of the fastening collar 102 on installation. The threaded region, annular shoulder, groove, and/or other feature can be external relative to the shank 122. In various non-limiting embodiments, all or a portion of the shank 122 includes grooves. For example, as shown in FIGS. 1A-1B, the shank 122 of the pin 120 includes grooves 126. In other non-limiting embodiments, all or a portion of the shank 122 lacks grooves. In various non-limiting embodiments, a portion of the shank 122 includes an annular shoulder. In other non-limiting embodiments, the shank 122 lacks an annular shoulder. In various non-limiting embodiments, a portion of the shank 122 includes a threaded portion. In other non-limiting embodiments, the shank 122 lacks a threaded portion.

The collar cavity 110 of the fastening collar 102 can be configured to at least partially receive the shank 122 of the pin 120 therein. For example, the collar cavity 110 can comprise a shape suitable to receive the shank 122 of the pin 120, such as, for example, a generally cylindrical shape. During and/or after introduction of the shank 122 into the collar cavity 110, the fastening collar 102 can be at least partially deformed (e.g., swaged) onto the shank 122 responsive to forcible contact between the fastening collar 110 and a fastening collar installation apparatus, as described below. The deformation can secure the fastening collar 102 to the shank 122.

In various non-limiting embodiments, the pin 120 may not comprise a breakneck groove or other feature configured to fracture upon installation of the multi-piece fastener 100, and the pull region 124 may stay intact after installation. In various other non-limiting embodiments, the pin 120 may comprise a breakneck groove (not shown) or other feature configured to fracture upon installation of the multi-piece fastener 100. In certain other non-limiting embodiments, the pin 120 may not comprise a breakneck groove and may still be configured to fracture upon installation of the multi-piece fastener 100. Thus, according to various non-limiting embodiments, the multi-piece fastener 100 according to the present disclosure, may be installed into a structure without fracturing of a breakneck groove or other feature, or a breakneck groove or other feature may be provided and may be fractured upon installation of the multi-piece fastener into the structure.

The multi-piece fastener system according to the present disclosure can comprise at least one of a metal, a metal alloy, a composite material, and another suitable material. For example, in various non-limiting embodiments, the multi-piece fastener 100 can comprise at least one of aluminum, an aluminum alloy, titanium, a titanium alloy, nickel, a nickel alloy, iron, an iron alloy, and a carbon fiber composite material. In various non-limiting embodiments, the multi-piece fastener 100 comprises steel, such as, for example, stainless steel.

FIGS. 2A-B illustrate a non-limiting embodiment of fastening collar installation apparatus 240 according to the present disclosure. The fastening collar installation apparatus 240 can engage at least a portion of a fastener system (e.g., the pull region 124 of the pin 120 of the fastener system illustrated in FIGS. 1A-B) and/or deform a portion of the fastener system (e.g., deform the fastening collar 102 and/or break the pin 120 of the multi-piece fastener system 100 illustrated in FIGS. 1A-B). The fastening collar installation apparatus 240 can be configured with various components in order to engage a pin of the multi-piece fastener, deform the fastening collar onto the pin, and/or break the pin. For example, the fastening collar installation apparatus 240 can comprise an anvil 242, a housing 244, and a collet 246.

The housing 244 can be configured to receive and/or retain various components. For example, the housing 244 can comprise a housing cavity 268 extending along a longitudinal axis of the housing 244 from a first housing end 248 to the second housing end 250. In various non-limiting embodiments, the housing 244 can be substantially cylindrical. The housing cavity 268 can be configured to at least partially receive the collet 246.

The anvil 242 can be configured to engage and/or deform a fastening collar of a multi-piece fastener system (e.g., fastening collar 102 in FIGS. 1A-1B). For example, in various non-limiting embodiments, the anvil 242 can be operatively coupled to the housing 244 and positioned adjacent to the first housing end 248. In various non-limiting embodiments, the anvil 242 is in direct contact with the first housing end 248. The anvil 242 can comprise an anvil cavity 270 extending along a longitudinal axis of the anvil 242. The anvil cavity 270 can be configured to receive at least a portion of the multi-piece fastener 100, such as, for example, at least a portion of the fastening collar 102 and/or the pin 120. For example, in various non-limiting embodiments, the anvil 242 can have a toroidal shape.

The collet 246 can be sized and configured such that the collet 246 can engage and/or move at least a portion of a fastener system (e.g., the pull region 124 of the pin 120 of the multi-piece fastener 100). The collet 246 can be positioned within the housing cavity 268 of the housing 244 and configured to move relative to the housing 244 and/or anvil 242 in order to draw a multi-piece fastener 100 engaged with the collet 246 into contact with the anvil 242, as described below with reference to FIGS. 5A-5D.

In various non-limiting embodiments, the collet 246 can comprise a first collet end 252 adjacent to the anvil 242, a second collet end 254, a collet cavity 266 extending from the first collet end 252, and an elongate portion 258. The elongate portion 258 can comprise at least two fingers formed by at least two axial channels formed in the elongate portion 258. For example, the elongate portion 258 can comprise three fingers 262a-c formed by three axial channels 264a-c as illustrated in FIG. 2A. In certain non-limiting embodiments, the axial channels 264a-c can be substantially parallel to a longitudinal axis of the collet 246. In various non-limiting embodiments, the fingers 262a-c can be radially spaced about the longitudinal axis of the collet 246, and in various non-limiting embodiments, the fingers 262a-c can be substantially equally radially spaced about the longitudinal axis of the collet 246. Equally radially spacing the fingers 262a-c about the longitudinal axis of the collet 246 can facilitate centering of a fastening collar within the collet cavity 266 when the fastening collar installation apparatus 240 is in use.

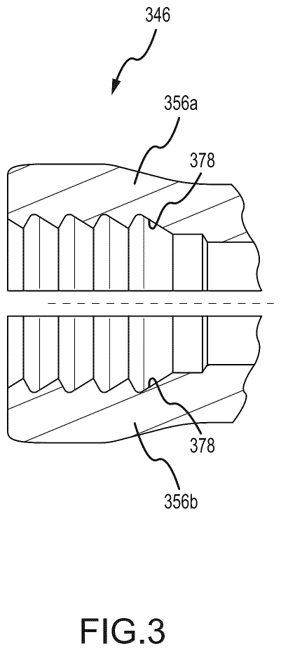

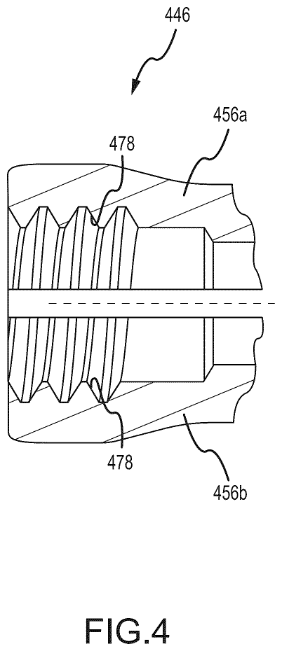

The first collet end 252 can comprise jaws to engage at least a portion of a fastener (e.g., the pull region 124). For example, in various non-limiting embodiments, each finger 262a-c can comprise a respective jaw 256a-c extending inwardly relative to the longitudinal axis of the collet 246 and the collet cavity 266. In various non-limiting embodiments, the jaws 256a-c can comprise an annular shoulder (not shown), a groove, a thread, and/or other feature (not shown). For example, referring to FIG. 3, a collet 346 is provided that comprises jaws 356a-b with grooves 378. As shown in the non-limiting embodiment illustrated in FIG. 4, a collet 446 is provided comprising jaws 456a-b including threads 478. In various non-limiting embodiments, the jaws 256a-c, 356a-b, and 456a-b can comprise a 30-degree/60-degree chuck draw.

Referring again to FIGS. 2A-B, the jaws 256a-c can be configured to forcibly contact at least a portion of a pull region 124 of the pin 120 of a multi-piece fastener 100 and to form, for example, an annular shoulder, a groove, a thread, and/or other feature on the pull region 124. In various non-limiting embodiments, the jaws 256a-c can cold form an annular shoulder, a groove, a thread, and/or other feature onto the pull region 124 of the pin 120. The process of forming an annular shoulder, a groove, a thread, and/or other feature on the pull region 124 can increase the tensile strength and/or shear strength of the pin 120, which can increase the reliability of the multi-piece fastener 100 after installation. Additionally, forming the annular shoulder, groove, thread, and/or other feature on a generally cylindrical and smooth pull region 124 can increase the engagement between the collet 246 and the pin 120 compared to engagement between a collet and a pin pull region including a preformed annular shoulder, groove, thread, and/or other feature.

In various non-limiting embodiments, the fastening collar installation apparatus 240 may form a single annular shoulder, groove, thread, or other feature on the pull region 124 of the pin 120. In certain non-limiting embodiments, the fastening collar installation apparatus 240 may form at least two annular shoulders, grooves, threads and/or other features on the pull region 124 of the pin 120.

The collet 246 can be a single, continuous piece or can comprise multiple pieces. For example, the fingers 262a-c can be joined together by bonding or other techniques or can be formed from a single piece of material. In certain non-limiting embodiments, the fingers 262a-c can be independently moveable relative to one another and are not joined together.

The collet 246 can be independently moveable relative to the housing 244 and/or anvil 242. For example, after engagement with the pull region 124 of the multi-piece fastener 100, the collet 246, including the jaws 256a-c, can be configured to retract within the housing 244 and move the pull region 124 distal from the fastening collar 102 of the multi-piece fastener 100. The movement of the collet 246 can be responsive to a linear force acting on the collet.

For example, in various non-limiting embodiments of the installation tool 240 the second collet end 254 can be configured to engage a tool that can generate a linear force, such as, for example, a piston of a powered installation tool. The powered installation tool can be a battery-powered tool, such as, for example, at least one of a Huck® Range Force™ battery-powered installation tool; a pneumatic tool, such as, for example, a Huck® 254 pneumatic tool; and a hydraulic tool, such as, for example, a Huck® SF hydraulic tool, all available from Arconic Fasteners, Waco, Texas. In various non-limiting embodiments, as illustrated in FIG. 2B, the collet 246 can be engaged with an adapter 260 that can engage a tool that can generate a linear force.

The fastening collar installation apparatus 240 can comprise at least one of a metal, a metal alloy, a composite material, and another suitable material. For example, in various non-limiting embodiments, the fastening collar installation apparatus 240 can comprise at least one of aluminum, an aluminum alloy, titanium, a titanium alloy, nickel, a nickel alloy, iron, an iron alloy, and a carbon fiber composite material. In various non-limiting embodiments, the collet 246 can comprise a first material with a first hardness, and the pin 120 can comprises a second material with a second hardness. In certain non-limiting embodiments, the first hardness can be greater than the second hardness such that the collet 246 can deform the pull region 124 of first pin end 128 of the pin 120. Therefore, the jaws 256a-c can apply a force to a surface of the pull region 124 that is greater than a yield strength of the second material in order to form an annular shoulder, a groove, a thread, and/or other feature on the pull region 124.

As illustrated in FIGS. 5A-5D, the multi-piece fastener 100 can be installed into a bore 572 of a structure 570. As illustrated, the bore 572 can extend through the structure 570 from a first side 574 to a second side 576.

The structure 570 can comprise, for example, at least one of a metal, a metal alloy, a composite material, or another suitable material. For example, in certain non-limiting embodiments, the structure 570 can comprise at least one of aluminum, an aluminum alloy, titanium, a titanium alloy, nickel, a nickel alloy, iron, an iron alloy, and a carbon fiber composite material. In various non-limiting embodiments, the structure 570 into which the multi-piece fastener 100 is assembled comprises aluminum and/or an aluminum alloy, such as, for example, 7075 aluminum alloy. With reference to the accompanying figures, in various non-limiting embodiments the structure 570 can be configured as at least one of an aerospace component or structure, an automotive component or structure, a transportation component or structure, a building and construction component or structure, or another component or structure.

The structure 570 can comprise a single layer of material or at least two layers of material. For example, as illustrated in FIGS. 5A-5D, the structure 570 can comprise a first layer 570a and a second layer 570b. The first layer 570a can be intermediate the second layer 570b and the fastening collar 102 when the fastening collar 102 is installed. In various non-limiting embodiments, the first layer 570a is adjacent to the fastening collar 102.

The bore 572 can have a bore diameter, Ø_{b}. Additionally, to facilitate alignment of the multi-piece fastener 100 with the bore 572, the second diameter, Ø₂, of the shank 122 can be sized and configured to be less than the bore diameter, Ø_{b}, thereby allowing the second pin end 130 to be readily disposed into and through the bore 572. In various non-limiting embodiments, the bore diameter, Ø_{b}, can be less than a diameter of the head portion 132 in order to inhibit the head portion 132 of the pin 120 from moving into the bore 572.

As illustrated in FIG. 5A, the second pin end 130 of the pin 120 was positioned in alignment with the bore 572 on the second side 576 of the structure 570 before being inserted through the bore 572. The fastening collar 102 has been positioned over the second pin end 130, and the second pin end 130 has been inserted into and through the collar cavity 110 of the fastening collar 102. The first collar end 104 of the fastening collar 102 has been positioned to contact the first layer 570a of the structure 570. For example, the fastening collar 102 can be in forcible contact with the structure 570, which can limit further axial movement of the fastening collar 102 relative to the pin 120 along the longitudinal axis of the multi-piece fastener 100. In various non-limiting embodiments in which the pin 120 and the fastening collar 102 comprise threads, inserting the second pin end 130 into the collar cavity 110 of the fastening collar 102 may require rotation of at least one of the fastening collar 102 and the pin 120.

Referring to FIG. 5B, the collet 246 of the fastening collar installation apparatus 240 has engaged the shank 122 of the pin 120 of the multi-piece fastener 100. For example, the collet 246 was positioned over the pull region 124 of the multi-piece fastener 100 and retracted within the housing 244 of the fastening collar installation apparatus 240, which has caused the collet 246 to forcibly contact the anvil 242 of the fastening collar installation apparatus 240. Responsive to the contact between the anvil 242 and the collet 246, the jaws 256a-c have closed around the pull region 124 and have forcibly contacted the pull region 124 of pin 120. The forcible contact between the jaws 256a-c and the pull region 124 has mechanically deformed the pull region 124 to form an annular shoulder, a groove, a thread, and/or other feature on the pull region 124, thereby engaging the collet 246 with the pin 120.

Upon engagement, the collet 246 can apply an axial force to the pull region 124 of the pin 120, which can decrease a gap, if present, between the first layer 570a and the second layer 570b of the structure 570 and create forcible contact between the fastening collar 102 and the structure 570. For example, referring to FIG. 5C, the collet 246 has further retracted within the fastening collar installation apparatus 240 and moved the pin 120 due to the engagement between the pull region 124 and the collet 246. As the collet 246 retracts within the housing 244 of the fastening collar installation apparatus 240, the anvil 242 can contact the fastening collar 102. After a predetermined force is achieved, the fastening collar 102 can be at least partially deformed responsive to the forcible contact between the anvil 242 and the fastening collar 102. For example, the fastening collar 102 can be swaged onto a generally smooth region, a threaded region, an annular shoulder, a groove, and/or other feature on a section of the shank 122 intermediate the first layer 570a and the second pin end 130. At least partially deforming the fastening collar 102 onto the shank 122 of the pin 120 can thereby secure the fastening collar 102 to the shank 122 and secure the multi-piece fastener 100 to at least a portion of the structure 570. In that way, for example, the first layer 570a and second layer 570b of the structure 570 are secured together (e.g., inhibited from axial movement along the longitudinal axis of the multi-piece fastener 100).

As illustrated in the non-limiting embodiment illustrated in FIG. 5D, after installation of the multi-piece fastener 100 into the structure 570, the fastening collar 102 and the head portion 132 of the pin 120 are applying a clamping force to the layers 570a-b of the structure 570, thereby securing the multi-piece fastener 100 to the structure 570 and securing layers 570a-b together. Additionally, an annular shoulder, a groove, a thread, and/or other feature has been formed on the pull region 124 of the pin 120 by the collet 246 of the fastening collar installation apparatus 240, thus providing a visual indication that the multi-piece fastener 100 has been installed. In various non-limiting embodiments, as illustrated in FIG. 5D, the pin 120 may not fracture after installation into the structure 570.

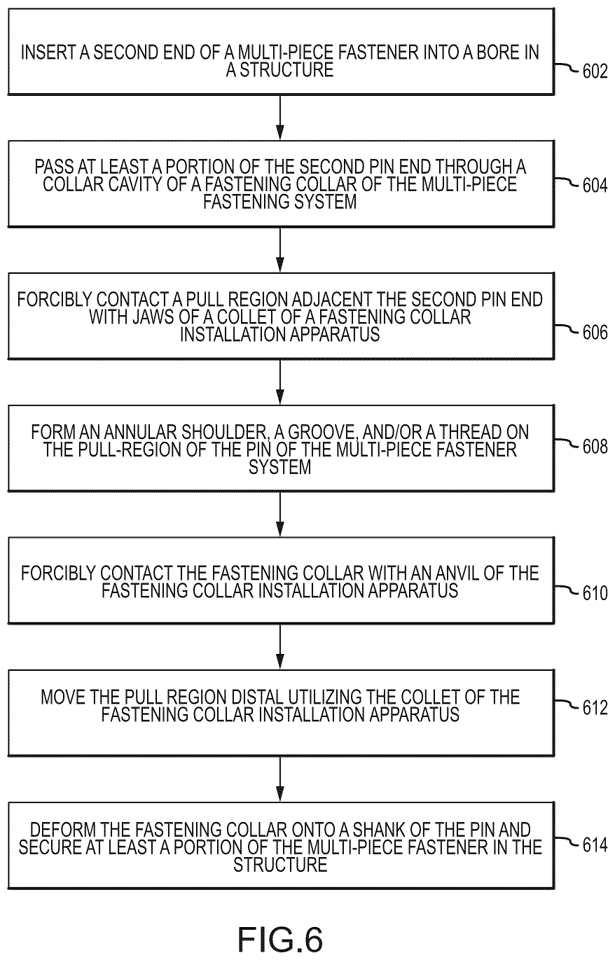

The present disclosure includes methods for installing a fastener and fastening a structure, as described and illustrated herein. In various non-limiting embodiments, referring to FIG. 6, the multi-piece fastener systems according to the present disclosure can be used in a method for fastening a structure. A second end of a multi-piece fastener according to the present disclosure can be inserted into a bore in a structure, 602. At least a portion of the second pin end can be passed through a collar cavity of a fastening collar of the multi-piece fastener according to the present disclosure, 604. The pull region of the pin can be forcibly contacted with jaws of a collet of a fastening collar installation apparatus according to the present disclosure, 606. An annular shoulder, a groove, a thread, and/or other feature can be formed on the pull region of the pin of the multi-piece fastener system according to the present disclosure by the jaws of the collet of the fastening collar installation apparatus according to the present disclosure, 608. For example, the jaws of the collet of the fastening collar installation apparatus according to the present disclosure can apply a force to a surface of the pull region that is greater than a yield strength of the pull region.

The fastening collar can be forcibly contacted with an anvil of the fastening collar installation apparatus, 610. The pull region can be moved distal from the fastening collar utilizing the collet of the fastening collar installation apparatus according to the present disclosure, 612. Thereby, the fastening collar installation apparatus deforms the fastening collar onto the shank of the pin and secures at least a portion of the multi-piece fastener according to the present disclosure in the structure, 614.

Various aspects of the invention include, but are not limited to, the aspects listed in the following numbered clauses.

1. A multi-piece fastener comprising:
a fastening collar comprising
   a first collar end; and
   a second collar end,
   wherein a collar cavity extends from the first collar end to the second collar end; and
a pin configured to be at least partially received by the collar cavity, the pin comprising
   a first pin end comprising a head portion;
   a second pin end comprising a pull region, wherein the pull region is generally cylindrical and smooth and is configured to form at least one of an annular shoulder, a groove, a thread, and other feature thereon responsive to forcible contact from a fastening collar installation apparatus; and
   a shank extending intermediate the first pin end and the second pin end, wherein the fastening collar is configured to be deformed onto the shank.

2. The multi-piece fastener of clause 1, wherein the pull region comprises an axial length no greater than 4 times a diameter of the shank.

3. The multi-piece fastener of any one of clauses 1-2, wherein the shank comprises at least one of an annular shoulder, a groove, and a threaded region.

4. The multi-piece fastener of any one of clauses 1-3, wherein the pull region is free of an annular shoulder, grooves, threads, and other features prior to forcible contact from a fastening collar installation apparatus.

5. The multi-piece fastener of any one of clauses 1-4, wherein the fastening collar is generally cylindrical.

6. The multi-piece fastener of any one of clauses 1-5, wherein the fastening collar comprises a flange.

7. The multi-piece fastener of any one of clauses 1-6, wherein the multi-piece fastener is adapted to be installed in a bore in a structure, the bore having a diameter less than a diameter of the head portion.

8. The multi-piece fastener of clause 7, wherein the structure is configured as at least one of an aerospace part or component, an automotive part or component, a transportation part or component, and a building and construction part or component.

9. The multi-piece fastener of any one of clauses 1-8, wherein the multi-piece fastener comprises at least one of a metal, a metal alloy, and a composite.

10. The multi-piece fastener of any one of clauses 1-9, wherein a diameter of the shank is in a range of 0.06 inches to 4 inches.

11. The multi-piece fastener of any one of clauses 1-10, wherein a diameter of the shank is in a range of 0.06 inches to 1 inches.

12. The multi-piece fastener of any one of clauses 1-11, wherein a diameter of the shank is in a range of 0.06 inches to 0.5 inches.

13. A lockbolt comprising the multi-piece fastener of any one of clauses 1-12.

14. A fastening collar installation apparatus comprising:
a housing comprising
   a first housing end;
   a second housing end, and
   wherein a housing cavity extends from the first housing end to the second housing end;
an anvil positioned within the housing cavity; and
a collet positioned within the housing cavity, the collet comprising a first collet end adjacent to the anvil, the first collet end comprising jaws configured to forcibly contact at least a portion of a pull region of a multi-piece fastener and to form at least one of an annular shoulder, a groove, a thread, and other feature on the pull region.

15. The fastening collar installation apparatus of clause 14, wherein the jaws of the collet comprise at least one of an annular shoulder, a groove, a thread, and other feature.

16. The fastening collar installation apparatus of any one of clauses 14-15, wherein the collet is a single, continuous piece or multiple pieces.

17. The fastening collar installation apparatus of any one of clauses 14-16, wherein the collet comprises:
a second collet end; and
an elongate portion extending from the first collet end to the second collet end, the elongate portion comprising at least two fingers formed by at least two axial channels in the elongate portion.

18. The fastening collar installation apparatus of any one of clauses 14-17, wherein the multi-piece fastener comprises:
a fastening collar comprising
   a first collar end; and
   a second collar end,
   wherein a collar cavity extends from the first collar end to the second collar end; and
a pin configured to be at least partially received by the collar cavity, the pin comprising
   a first pin end comprising a head portion;
   a second pin end comprising the pull region, wherein the pull region is generally cylindrical and smooth, and is configured to form at least one of an annular shoulder, a groove, a thread, and other feature thereon responsive to forcible contact from the fastening collar installation apparatus; and
   a shank extending intermediate the first pin end and the second pin end, wherein the fastening collar is configured to be deformed onto the shank.

19. A method for fastening, the method comprising:
inserting a second pin end of a multi-piece fastener into a bore in a structure, the multi-piece fastener comprising
   a fastening collar comprising
      a first collar end; and
      a second collar end,
      wherein a collar cavity extends from the first collar end to the second collar end; and
   a pin configured to be at least partially received by the collar cavity, the pin comprising
      a first pin end comprising a head portion;
      the second pin end comprising a pull region, wherein the pull region is generally cylindrical and smooth; and
      a shank extending intermediate the first pin end and the second pin end;
passing at least a portion of the second pin end through the collar cavity;
forcibly contacting the pull region of the pin with jaws of a collet of a fastening collar installation apparatus and forming at least one of an annular shoulder, a groove, a thread, and other feature on the pull region; and
forcibly contacting the fastening collar with an anvil of the fastening collar installation apparatus and moving the pull region distal from the fastening collar utilizing the collet of the fastening collar installation apparatus, thereby deforming the fastening collar onto the shank of the pin and securing at least a portion of the multi-piece fastener in the structure.

20. The method of clause 19, wherein the fastening collar installation apparatus comprises:
a housing comprising
   a first housing end; and
   a second housing end,
   wherein a housing cavity extends from the first housing end to the second housing end,
wherein the anvil and the collet are positioned within the housing cavity,
wherein the collet comprises a first collet end adjacent to the anvil, the first collet end comprises the jaws, and the collet is a single, continuous piece.

21. The method of any one of clauses 19-20, wherein the collet comprises a first material with a first hardness, the pin comprises a second material with a second hardness, and the first hardness is greater than the second hardness.

22. The method of any one of clauses 19-21, wherein forcibly contacting the pull region of the pin with jaws of the collet of the fastening collar installation apparatus and forming at least one of an annular shoulder, a groove, a thread, and other feature on the pull region comprises applying a force with the jaws to a surface of the pull region that is greater than a yield strength of the pull region.

One skilled in the art will recognize that the herein described fasteners, structures, operations/actions, and objects, and the discussion accompanying them, are used as examples for the sake of conceptual clarity and that various configuration modifications are contemplated. Consequently, as used herein, the specific examples/embodiments set forth and the accompanying discussion are intended to be representative of their more general classes. In general, use of any specific exemplar is intended to be representative of its class, and the non-inclusion of specific components, devices, apparatus, operations/actions, and objects should not be taken as limiting. While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

1-18. (canceled)

19. A method for fastening, the method comprising:
inserting a second pin end of a multi-piece fastener into a bore in a structure, the multi-piece fastener comprising
a fastening collar comprising
a first collar end; and
a second collar end,
wherein a collar cavity extends from the first collar end to the second collar end, and
a pin configured to be at least partially received by the collar cavity, the pin comprising
a first pin end comprising a head portion;
the second pin end comprising a pull region, wherein the pull region is generally cylindrical and smooth; and
a shank extending intermediate the first pin end and the second pin end;
passing at least a portion of the second pin end through the collar cavity;
forcibly contacting the pull region of the pin with jaws of a collet of a fastening collar installation apparatus and forming at least one of an annular shoulder, a groove, a thread, and other feature on the pull region; and
forcibly contacting the fastening collar with an anvil of the fastening collar installation apparatus and moving the pull region distal from the fastening collar utilizing the collet of the fastening collar installation apparatus, thereby deforming the fastening collar onto the shank of the pin and securing at least a portion of the multi-piece fastener in the structure.

20. The method of claim 19, wherein the fastening collar installation apparatus comprises:
a housing comprising
a first housing end; and
a second housing end,
wherein a housing cavity extends from the first housing end to the second housing end,
wherein the anvil and the collet are positioned within the housing cavity,
wherein the collet comprises a first collet end adjacent to the anvil, the first collet end comprises the jaws.

21. The method of claim 19, wherein the collet comprises a first material with a first hardness, the pin comprises a second material with a second hardness, and the first hardness is greater than the second hardness.

22. The method of claim 19, wherein forcibly contacting the pull region of the pin with jaws of the collet of the fastening collar installation apparatus and forming at least one of an annular shoulder, a groove, a thread, and other feature on the pull region comprises applying a force with the jaws to a surface of the pull region that is greater than a yield strength of the pull region.

23. The method of claim 20, wherein the jaws of the collet comprise at least one of an annular shoulder, a groove, a thread, and other feature.

24. The method of claim 20, wherein the collet is a single, continuous piece.

25. The method of claim 20, wherein the collet is multiple pieces.

26. The method of claim 20, wherein the collet comprises:
a second collet end; and
an elongate portion extending from the first collet end to the second collet end, the elongate portion comprising at least two fingers formed by at least two axial channels in the elongate portion.

27. The method of claim 20, wherein the multi-piece fastener comprises:
a fastening collar comprising
a first collar end; and
a second collar end,
wherein a collar cavity extends from the first collar end to the second collar end; and
a pin configured to be at least partially received by the collar cavity, the pin comprising
a first pin end comprising a head portion;
a second pin end comprising the pull region, wherein the pull region is generally cylindrical and smooth and is configured to form at least one of an annular shoulder, a groove, a thread, and other feature thereon responsive to forcible contact from the fastening collar installation apparatus; and
a shank extending intermediate the first pin end and the second pin end, wherein the fastening collar is configured to be deformed onto the shank.

28. The method of claim 19, wherein the pull region comprises an axial length no greater than 4 times a diameter of the shank.

29. The method of claim 19, wherein the shank comprises at least one of an annular shoulder, a groove, a threaded region, and other feature.

30. The method of claim 19, wherein the pull region is free of an annular shoulder, grooves, threads, and other feature prior to forcible contact from a fastening collar installation apparatus.

31. The method of claim 19, wherein the fastening collar is generally cylindrical.

32. The method of claim 19, wherein the fastening collar comprises a flange.

33. The method of claim 19, wherein the bore has a diameter less than a diameter of the head portion.

34. The method of claim 33, wherein the structure is configured as at least one of an aerospace part or component, an automotive part or component, a transportation part or component, and a building and construction part or component.

35. The method of claim 19, wherein a diameter of the shank is in a range of 0.06 inches to 4 inches.

36. The method of claim 19, wherein the multi-piece fastener is a lockbolt.

37. The method of claim 19, wherein forming at least one of an annular shoulder, a groove, and a thread is formed on the pull region.
